(19) United States
(12) Patent Application Publication
(10) Pub. No.: US 2007/0080217 A1
(43) Pub. Date: Apr. 12, 2007

(54) Alarm password for triggering a security response

(76) Inventor: Richard Brabant, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/245,981

(22) Filed: Oct. 6, 2005

(51) Int. Cl. G06K 5/00

(52) U.S. Cl. 235/382; 235/380

(57) ABSTRACT

In an embodiment of the invention, a method for providing security to an account, includes: providing a code; validating the code; if the code is an access code for accessing an account, then permitting transactions on the account if the access code is valid; and if the code is an alarm password associated with the account, then preventing transactions on the account if the alarm password is valid. Another embodiment of the invention provides an apparatus or system that can perform the above method.

### TECHNICAL FIELD

Embodiments of the invention relate generally to network systems, and more particularly to an alarm password for triggering a security response.

### BACKGROUND

Automatic Teller Machines (ATMs) are now commonly used by banking customers (and by customers of other financial institutions). ATMs permit customers to, for example, withdraw cash, deposit cash, transfer balances between accounts, and/or perform other financial-related transactions that concern the customer's checking account, savings account, credit card account, loan account, line of credit account, or other types of financial accounts of the customer. A customer can also withdraw funds from a bank account by use of other types of devices such as, for example, point-of-sale machines or via the Internet by use of a computer.

In order to access an ATM machine, the customer is typically required to insert an ATM card into the ATM machine and input an access code (i.e., a Personal Identification Number or PIN, or password) into the ATM machine. The ATM card will contain the account number of the customer's financial account. If the customer uses other types of devices (e.g., computers, point-of-sale machines, or other devices) to carry out a financial transaction, the customer must also provide an account card or input the account number, and then input an associated access code.

However, if an unauthorized individual obtains the customer's ATM machine or account number, and also determines the customer's access code, then the unauthorized individual will be able to illegally access the customer's financial account and withdraw funds from the account or perform other unauthorized activities on the account. Therefore, the account protection offered by the requirement of an access code is sometimes deficient in protecting an account of a customer.

Therefore, the current technology is limited in its capabilities and suffers from at least the above constraints and deficiencies.

### SUMMARY OF EMBODIMENTS OF THE INVENTION

An embodiment of the invention provides a method for providing security to an account, the method comprising: providing a code; validating the code; if the code is an access code for accessing an account, then permitting transactions on the account if the access code is valid; and if the code is an alarm password associated with the account, then preventing transactions on the account if the alarm password is valid.

Another embodiment of the invention provides an apparatus or system that performs the above method.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of a system (apparatus), in accordance with an embodiment of the invention.

FIG. 2 is a flowchart of a method, in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

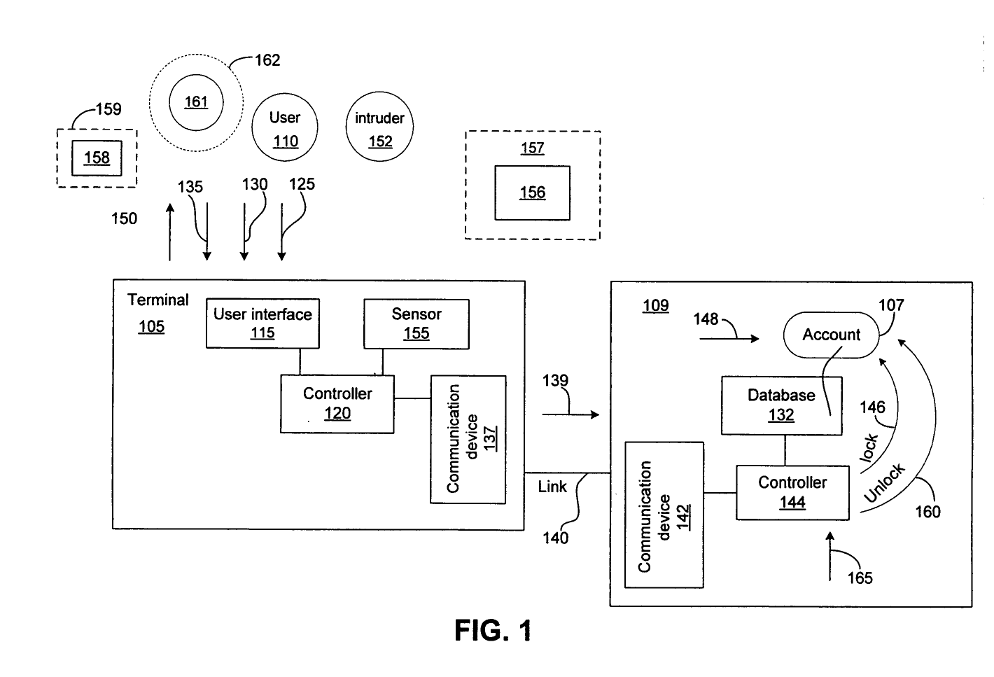

FIG. 1 is a block diagram of a system (apparatus) 100, in accordance with an embodiment of the invention. The system 100 includes a remote transaction terminal 105 that a user 110 will use to perform a transaction on an account 107 of the user. The account 107 is, for example, a bank account (e.g., savings, checking, line-of-credit, or other account) or other financial account of the user 110. Typically, the account 107 is maintained by an institution 109 which may be, for example, a bank or other businesses or organization. For example, the user 110 can use the terminal 105 to deposit funds into or withdraw funds from a checking account, savings account, line-of-credit account, or other financial account of the user 110. One example of the terminal 105 is the ATM machine. In other applications, the user 110 can use the terminal 105 for other use that also have security restrictions. For example, the user 110 can use the terminal 105 for accessing a 401K account of the user 110, an employee file of the user 110, medical records of the user 110, or other accounts of the user 110. In other applications, the user 110 is accessing the terminal 105 which may be, for example, a computer device such as a personal computer, notebook computer, laptop computer, workstation, server, or other computing device, and access to the terminal 105 is restricted. In other applications, the user 110 may be accessing the terminal 105 in order to access a secured network area such as, for example, a donation website, a client webpage, or other secured areas in a network. In other applications, the user 110 may be using the terminal 105 which may be a type of device such as, for example, test tools or other devices that may have access restrictions or use restrictions.

In an embodiment of the invention, the terminal 105 includes a user interface 115 which permit the user 110 to provide input into the terminal 105 and to receive output from the terminal 105. For example, the user interface 115 can include keypads which the user 110 can use to input access code and other transaction-related input into the terminal 105, a touch-screen which the user 110 can use to input an access code for his/her account and other transaction-related input into the terminal 105, a screen which displays messages to the user 110, a cash bin (if the terminal 105 is an ATM machine) that outputs cash to the user 110, a slot for receiving an ATM card, credit card, or other account cards of the user 110, and/or other components that permits the user 110 to carry out a transaction by use of the terminal 105. Various known configurations for the user interface 115 may be implemented for the terminal 105.

The terminal 105 can have its own controller 120 which assists in carrying out the transaction for the user 110, as discussed further below. Alternatively, the controller 120 of the terminal 105 can be located in the premises of a bank or other facility, and is communicatively linked to the controller 120.

When the user 110 provides an account number 125 into the terminal 105, the controller 120 will validate the account number 125 to determine if the account number is associated with a valid account 107. The user 110 can provide the account number 125 by typically inserting an account card (e.g., ATM card or credit card) into the user interface 115 or by directly typing the account number 125 into keypads or a touch-screen of the interface 115. The user 110 also inputs an access code 130 (e.g., PIN code) into the terminal 105, where the access code 130 is required for access into the account 107. Typically, the access code 130 is a four-digit code of numerals, alphabets, or a combination of numerals and alphabets. The length of the access code 130 may also vary (e.g., 6-digits, 8-digits, or other lengths). Typically, the user 110 can pre-select the particular access code 130 for his/her account 107. The controller 120 will validate the access code 130, in order to determine if the access code 130 is the proper access code for the account 107. If the access code 130 is the proper access code for the account 107, then the controller 120 will permit the user 110 to access the account 107 and to perform one or more transactions with the account 107. For example, a transaction may involve depositing cash or a check into the account 107, withdrawing cash from the account 107, perform a fund transfer with the account 107, or performing other known transactions with the account 107. The controller 120 validates the access code 130 by comparing the access code 130 provided by the user 110 with a stored access code that is required for access into the account 107. The account 107, account number associated with the account 107, stored access code associated with the account 107, and other information associated with the account 107 is typically stored in a database 132 which is maintained by the institution (e.g., bank) 109.

In an embodiment of the invention, the user 110 inputs an alarm password 135 which is different from the access code 125. Typically, the alarm password 135 is a four-digit code of numerals, alphabets, or a combination of numerals and alphabets. The length of the alarm password 135 may also vary (e.g., 6-digits, 8-digits, or other lengths). Typically, the user 110 can pre-select the particular alarm password 135 for his/her account 107. When user 110 enters the alarm password 135 into the user interface 115 of the terminal 105, the controller 120 will validate the alarm password 135, in order to determine if the alarm password 135 is the proper alarm password for the account 107. If the alarm password 135 is the proper alarm password for the account 107, then the controller 120 will enable the communication device 137 to transmit an alarm signal 139 via link 140 to the organization 109. The alarm signal 139 is received and processed by a communication device 142 which is associated with the organization 109. The link 140 may be a wired link or wireless link that permits the terminal 105 and the organization 109 to communicate with each other. The communication devices 137 and 142 may be any standard communication devices that permit communication to occur, such as, for example, transceivers, data packet transmitters and receivers, or other known communication devices.

The alarm signal 139 includes the account number 125 which identifies the account 107. The communication device 142 permits a controller 144 to process the alarm signal 139 and identify the account number 125. The controller 144 can then sent a lock signal 146 to the database 132, where the lock signal 146 will lock the account 107 associated with the account number 125. When the account 107 is locked (frozen), then transactions 148 will not be permitted on the account 107. Known methods or software can also be used to lock an account 107. A transaction 148 may include, for example, withdrawing funds or depositing funds into the account 107, performing a balance transfer on the account 107, or other types of known transactions. Therefore, cash will not be withdrawn from the account 107 and output from the user interface 115 of the terminal 105. Therefore, the alarm password 135 allows a user 110 to protect and prevent transactions 148 on his/her account 107 in real time, when the user 110 inputs the alarm password 135 into the terminal 105. Also, the alarm password 135 allows an improved method to protect accounts 107 from identity theft, unauthorized transactions, or actions that may be detrimental to the account 1067 of the user 110. Additionally, by use of the alarm password 135, the user 110 can lock his/her account 107 without the assistance of a banker or other personnel of the organization 109.

In another embodiment of the invention, after the controller 120 has determined that the alarm password 135 is the proper alarm password for the account 107, the controller 120 can enable the user interface 115 to display a false message 150, as an option. For example, the false message 150 can display on a screen of the user interface 115 (or provide as an audio signal on a speaker of the user interface 115) a message indicating that the terminal 105 is unable to process the user's transaction due to mechanical problems. Therefore, if an intruder 152 (or other unauthorized individual) is forcing the user 110 to withdraw cash from the account 107, the user 110 can enter the alarm password 135, and in response to the alarm password 135, the false message 150 will advantageously deceive the intruder 152 into believing that the terminal 105 is non-operational.

In another embodiment of the invention, a sensor 155 can detect the presence of an intruder 152, as an option. The sensor 155 can detect the presence of the user 110 and the presence of the intruder 152 near the terminal 155. The controller 120 will only process the alarm password 135 that is input into the terminal 105 as described in the above method, if the sensor 155 detects the presence of the intruder 152. As a result of processing of the alarm password 135, the account 107 will be locked 146 and transactions 148 will not be accepted and will not be performed for the account 107. If the sensor 155 does not detect the presence of the intruder 152, then the controller 120 will not process the alarm password 135. As a result, the account 107 will not be locked 146 and transactions 148 will continue to be accepted and will continue to be performed for the account 107. This embodiment of the invention provides additional safeguards for permitting the use of the alarm password 135.

As an example, the sensor 155 can detect the presence of the intruder 155 by use of known infrared detection methods, known image detection methods, or other known physical sensing methods.

Additionally, the sensor 155 can have a video recording feature or/and picture-taking (or/and image recording) features (e.g., camera or video recorder) after the controller 120 has received the alarm password 135, so that a visual profile of the intruder 152 is recorded by the sensor 155. Proper authorities can then later examine the visual profile of the intruder 152.

Additionally or alternatively, the sensor 155 can have an audio recording feature (e.g., audio recorder). Therefore, the sensor 155 will record an audio profile of the intruder 152, after the controller 120 has received the alarm password 135. Proper authorities can then later examine the audio profile of the intruder 152.

Additionally or alternatively, an additional sensor 156 can be placed in another proper position or location 157 for improved detection of the intruder 152. The sensor 156 can have at least some of the above-mentioned features of the sensor 155. Proper positioning of various types of sensors for improved sensor detection functionalities are known to those skilled in the art.

Additionally or alternatively, an additional sensor 158 can be placed in another proper position or location 159 for improved detection of another intruder 161 who may be at a different position 162 with respect to the user 110. The sensor 158 can have at least some of the above-mentioned features of the sensor 155. Other locations for the sensors shown in FIG. 1 can be used for improved detection of intruders. Additionally, the number of sensors used in FIG. 1 may vary, and other additional sensors may be placed in other locations with respect to the user 110.

If the account 107 has been locked 146, then the account 107 can be subsequently unlocked by an unlock signal 160 from the controller 144. When the account 107 is unlocked, then the transactions 148 can be received by and performed on the account 107. As an example, a banker or teller (or other authorized personnel) of the organization 109 can provide an unlock code 165 to the controller 144, so that the controller can send the unlock signal 160 to unlock an account 107.

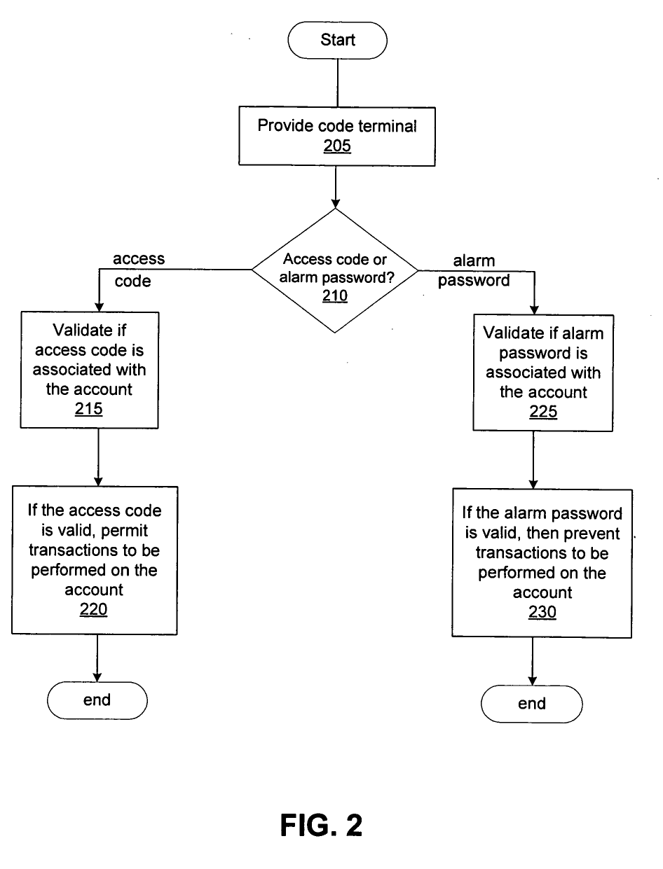

FIG. 2 is a flowchart of a method 200, in accordance with an embodiment of the invention. In block 205, the user provides a code into a terminal. The user also provides an account number 125 associated with an account 107. The code can be access code 130 for the account or an alarm password 135 associated with the account.

In block 210, the code can be an access code 130 or an alarm password 135. If the code is an access code 130, then in block 215, the access code 130 is validated by the controller 120, so that the controller 120 can determine if the access code 130 is the proper code for accessing the account 107. In block 220, if the controller 120 determines the access code 130 as valid (i.e., the access code 130 is the proper code for accessing the account 107), then a controller 144 will permit transactions 148 to be performed on the account 107.

On the other hand, if the code is an alarm password 135, then in block 225, the alarm password 135 is validated by the controller 120, so that the controller 120 can determine if the alarm password 135 is the proper alarm password that is associated with the account 107. In block 230, if the controller 120 determines the alarm password 135 as valid (i.e., the alarm password 135 is associated with the account 107), then a controller 144 will prevent transactions 148 to be performed on the account 107.

Various elements in the drawings may be implemented in hardware, software, firmware, or a combination thereof.

The various engines or software discussed herein may be, for example, computer software, firmware, commands, data files, programs, code, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing disclosure. Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of an embodiment of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

It is also noted that the various functions, variables, or other parameters shown in the drawings and discussed in the text have been given particular names for purposes of identification. However, the function names, variable names, or other parameter names are only provided as some possible examples to identify the functions, variables, or other parameters. Other function names, variable names, or parameter names may be used to identify the functions, variables, or parameters shown in the drawings and discussed in the text.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for providing security to an account, the method comprising:
providing a code;
validating the code;
if the code is an access code for accessing an account, then permitting transactions on the account if the access code is valid; and
if the code is an alarm password associated with the account, then preventing transactions on the account if the alarm password is valid.

2. The method of claim 1, further comprising:
locking the account if the alarm password is valid.

3. The method of claim 2, further comprising:
subsequently unlocking the account to permit transactions on the account.

4. The method of claim 1, further comprising:
displaying a false message on a terminal if the alarm password is valid.

5. The method of claim 1, further comprising:
permitting the processing of the alarm password if an intruder is detected.

6. The method of claim 1, further comprising:
preventing the processing of the alarm password if an intruder is not detected.

7. The method of claim 1, wherein the account is managed by an organization.

8. The method of claim 1, wherein the code is received by a terminal.

9. An apparatus for providing security to an account, the apparatus comprising:
a terminal configured to receive a code, validate a code;
wherein if the code is an access code for accessing an account, then permitting transactions on the account if the access code is valid; and
wherein if the code is an alarm password associated with the account, then preventing transactions on the account if the alarm password is valid.

10. The apparatus of claim 9, further comprising:
a controller configured to lock the account if the alarm password is valid.

11. The apparatus of claim 10, wherein the controller is configured to subsequently unlock the account to permit transactions on the account.

12. The apparatus of claim 9, wherein the terminal is configured to display a false message if the alarm password is valid.

13. The apparatus of claim 9, wherein the terminal is configured to permit the processing of the alarm password if an intruder is detected.

14. The apparatus of claim 9 wherein the terminal is configured to prevent the processing of the alarm password if an intruder is not detected.

15. The apparatus of claim 9, wherein the account is managed by an organization.

16. An apparatus for providing security to an account, the apparatus comprising:
means for receiving a code;
means for validating the code;
means for permitting transactions on the account if the access code is valid if the code is an access code for accessing an account and for preventing transactions on the account if the alarm password is valid if the code is an alarm password associated with the account.

17. An article of manufacture, comprising:
a machine-readable medium having stored thereon instructions to:
receive a code;
validate the code;
permit transactions on the account if the access code is valid if the code is an access code for accessing an account and prevent transactions on the account if the alarm password is valid if the code is an alarm password associated with the account.
